(19) United States
(12) Patent Application Publication
(10) Pub. No.: US 2010/0064668 A1
(43) Pub. Date: Mar. 18, 2010

(54) METHOD FOR HEATING A REDUCING AGENT METERING VALVE IN AN SCR SYSTEM FOR EXHAUST GAS AFTER-TREATMENT IN AN INTERNAL COMBUSTION ENGINE

(75) Inventors: Thomas Beckmann, Stuttgart (DE); Matthias Horn, Freiberg (DE); Andreas George Mueller, Ceske Budejovice (CZ)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/517,471

(22) PCT Filed: Feb. 20, 2008
(86) PCT No.: PCT/EP2008/052068

§ 371 Date: Jun. 3, 2009

(30) Foreign Application Priority Data
Apr. 3, 2007 (DE) 102007017458.8

(51) Int. Cl. F01N 9/00; F16K 31/02

(52) U.S. Cl. 60/286; 251/129.15

(57) ABSTRACT

The invention relates to a method for the operation of an electromagnetically controllable reducing agent metering valve that is disposed in the exhaust gas system of an internal combustion engine and that is actuated with a first flow profile (46) for metering a reducing agent. The method is characterized in that a value is determined for the temperature of the reducing agent metering valve and compared to a threshold value and in that, if the temperature determined is less than the threshold value, an actuation of the reducing agent metering valve occurs with a second flow profile that is different from the first flow profile. The invention further relates to a control device that is equipped, particularly programmed, to control the progression of such a method.

### TECHNICAL FIELD

The invention relates to a method according to the preamble of claim 1 as well as to a control device according to the preamble of claim 11. Electromagnetically controllable reducing agent metering valves have a magnetic coil, whose magnetic field lifts a jet needle from a seal seat when a sufficiently large coil current is present and thus opens the reducing agent metering valve.

### BACKGROUND

In so doing, a first flow profile of the coil current serves the purpose of opening the reducing agent metering valve and/or of holding said valve open in order to control the flow rate of the reducing agent. Such a method as well as such a control device is known for utilization in motor vehicles, such as passenger cars and trucks, from the publication “Diesel-Management,” 4^{th} edition, Friedrich Vieweg and Son Publishing Company, ISBN 3-528-23873-9, page 338.

The selective reduction of nitrogen oxides (SCR=selective catalytic reduction) is based on the fact that selected reducing agents also reduce nitrogen oxides (NOx) when oxygen is present. Selective means in this connection that the oxidation of the reducing agent preferably (selectively) takes place with the oxygen of the nitrogen oxides and not with the molecular oxygen, which is significantly more plentiful in the exhaust gas. Ammonia (NH₃) has thereby proved itself to be the reducing agent with the highest selectivity. Ammonia is not carried along in a pure form in the motor vehicle but is metered into the exhaust gas from an available urea-water solution. Urea (NH₂)₂CO has a very good solubility in water and can therefore be easily metered into the exhaust gas. When discussing a reducing agent in this application, this term shall also designate precursors, carrier substances and carrier mediums like water, in which a carrier substance or the reducing agent is contained in a dissolved form. Hence the urea-water solution is also designated below as the reducing agent to be metered.

A urea-water solution, which is known under the trade name AdBlue, with a mass concentration of 32.5% urea freezes at −11EC. A eutectic forms at said freezing point, whereby segregation in the solution is impossible if freezing occurs.

Even if an undesirable segregation does not occur in this composition, a freezing up of the reducing agent metering valve and other components of the system, for example a freezing up of lines, must be prevented as far as possible. If the system is frozen up, the reducing agent could no longer be metered, which would result in increased emissions of nitrogen oxides by the motor vehicle. If the system should nevertheless freeze up during adverse environmental conditions, it must be able to be thawed out during the operation of the motor vehicle. This is particularly true for the reducing agent metering valve consisting as a rule of diverse metals and plastics. The reducing agent metering valve is disposed directly in the exhaust gas tract. The danger then exists that said valve will be overheated when the exhaust gas and the exhaust gas system are hot. In order to avoid such thermal damage, the reducing agent metering valve is as a rule equipped with a cooling element, which allows for a discharge of large amounts of heat to the atmosphere. In the opposite case of low temperatures, said cooling element increases the risk of the reducing agent metering valve freezing up and impedes a thawing of a frozen reducing agent metering valve.

### SUMMARY

Against this backdrop the task of the invention consists of preventing the freezing up of a reducing agent metering valve and/or of allowing for a thawing of such a reducing agent metering valve with the simplest possible means and at the lowest possible cost as well as with the highest possible operational reliability.

This task is solved in each case with the characteristics of the independent claims. Ascertaining a measurement for the temperature of the reducing agent metering valve and the comparison of the measurement with a threshold value allows for a detection of situations, in which the danger of the reducing agent metering valve freezing up exists.

According to the invention, the reducing agent metering valve is actuated in such a situation with a second flow profile that is different from the first flow profile. Whereas the first flow profile serves to control the flow rate by means of the reducing agent metering valve, the output of the second metering valve is carried out with the goal of releasing heat within the ohmic resistance of the coil, said heat warming the reducing agent metering valve from the inside out.

On account of this multiple use of the magnetic coil of the electrically controllable reducing agent metering valve on the one hand for controlling the flow cross-section and on the other hand as a heating coil, a separate heating device for the reducing agent metering valve can be omitted. The construction of the reducing agent metering valve is consequently simplified. Furthermore, the space requirement and the associated manufacturing costs are decreased, while the operating reliability is increased at the same time.

Additional advantages result from the dependent claims, the description and the accompanying diagrams.

It is to be understood that the abovementioned characteristics and those still to be explained below cannot only be used in the respectively specified combination but also in other combinations or individually by themselves without departing from the scope of the invention at hand.

### BRIEF DESCRIPTION OF THE DRAWINGS

Examples of embodiment of the invention are depicted in the drawings and are explained in detail in the following description. The following are in each case shown in schematic form:

FIG. 1 is a technical environment of the invention;

FIG. 2 illustrates configurations of a first and a second flow profile;

FIG. 3 is an equivalent circuit diagram of the reducing agent metering valve together with an output stage of a configuration of the control device;

FIG. 4 is an additional configuration in the form of an equivalent circuit diagram of the reducing agent metering valve together with an output stage; and

FIG. 5 is a configuration of a method according to the invention.

### DETAILED DESCRIPTION

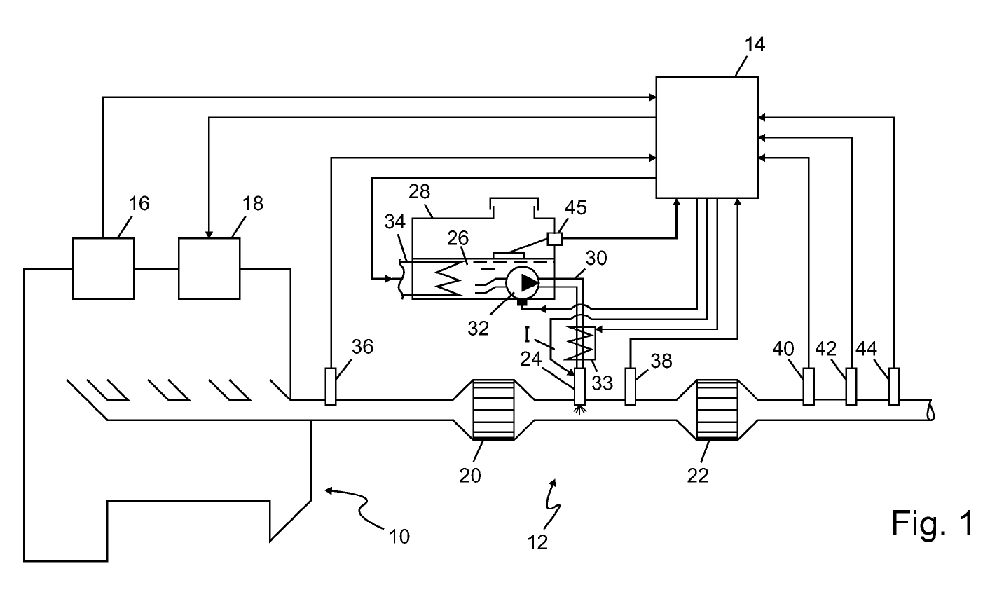

FIG. 1 shows an internal combustion engine 10 with an exhaust gas system 12 and a control device 14. The control device 14 preferably relates to the control device that controls the internal combustion engine 10 and in addition receives signals from a plurality of sensors 16 about operating parameters of the internal combustion engine 10 and then processes said signals into actuating variables for actuators 18 of the internal combustion engine 10. The signals from the plurality of sensors 16 typically allow the control device to make a determination of the air mass taken in by the internal combustion engine 10, the angular position of a crankshaft of the internal combustion engine 10, a temperature of the internal combustion engine 10, etc. The control device 14 typically forms actuating variables for the metering of fuel into the combustion chambers of the internal combustion engine, for the setting of a supercharging pressure of an exhaust gas turbocharger, an exhaust gas recirculation rate, etc. The control device 14 alternatively relates to a separate control device, which communicates with the control device of the internal combustion engine 10 via a bus system.

The exhaust gas system 12 has an oxidation catalytic converter 20 and an SCR catalytic converter 22. A reducing agent metering valve 24 is disposed between the oxidation catalytic converter 20 and the SCR catalytic converter 22. The reducing agent 26 is metered via said valve 24 from a storage container 28 into the exhaust gas. The reducing agent metering valve 24 is electromagnetically actuated and is to this end activated by the control unit 14 with a control current I that passes through a magnetic coil of the reducing agent metering valve 24. In so doing, the reducing agent metering valve 24 is supplied with the reducing agent 26 via a feed line 30, which is supplied with the reducing agent 26 by a pump 32. The pump 32 is preferably embodied as a controllable double-acting pump, which during the forcing operational mode produces the injection pressure necessary for the metering of the reducing agent 26 into the exhaust gas system 12 and during the suction operational mode allows for the reducing agent 26 to be emptied out of the feed line 30. For that purpose, the pump 32 is likewise controlled by the control device 14. The reducing agent 26 is emptied out of the feed line 30 in this fashion, for example, between two driving cycles, respectively at the end of a driving cycle, in order to avoid an intermittent freezing up of the reducing agent 26 in the feed line 30, which is mostly embodied as a flexible hose line, and in the reducing agent metering valve 24.

In order to avoid a freezing up of the reducing agent 26, the feed line 30 is additionally equipped with a hose heater 33, which is likewise controlled by the control device 14. An additional heater 34 is alternatively or supplementally disposed in the storage container 28, said heater 34 also being controlled by the control device 14.

Provision is furthermore made for different sensors 36, 38, 40, 42 and 44, which acquire operating parameters of the exhaust gas system 12 and provide corresponding data to the control device 14, to control the selective catalytic reduction of nitrogen oxides by a metering of the reducing agent 26 into the exhaust gas system 12 of the internal combustion engine 10. In one configuration, the sensors 36 and 40 relate to temperature sensors, while the sensor 38 preferably serves to acquire the NOx concentration in the exhaust gas upstream of the SCR catalytic converter 22. An additional NOx sensor is disposed downstream of the SCR catalytic converter 22. The sensor 44 acquires an ammonia concentration in the exhaust gas downstream of the SCR catalytic converter 22 and thereby allows for the determination of an overmetering of the reducing agent 26. A fill level sensor 45 acquires the reducing agent fill level in the storage container 28 and provides a corresponding signal to the control device 14.

FIG. 1 therefore shows in particular the technical environment, wherein the invention is used. In so doing, it is to be understood that the invention is not limited to the configuration depicted in FIG. 1 comprising an internal combustion engine 10 with an exhaust gas system 12 and all of the depicted sensors 16, 36, 38, 40, 42, 44, 45 and 46 and actuators 18, 24, 32, 33, 34.

With the procedural aspects of the invention in mind, it is essential that the reducing agent metering valve 24 is disposed in the exhaust gas system 12 of the internal combustion engine 10, that a metering of the reducing agent 26 is actuated with a first flow profile, that a value for the temperature of the reducing agent metering valve 24 is determined and compared to a threshold value and that then, if the temperature determined is less than the threshold value, an actuation of the reducing agent metering valve 24 occurs with a second flow profile that is different from the first flow profile.

With the control device 14, which is equipped for controlling the reducing agent metering valve 24, in mind, it is essential that the control device 14 is not only equipped for the purpose of actuating the reducing agent metering valve 24 with a first flow profile for metering a reducing agent but in addition is equipped for the purpose of determining a value for the temperature of the reducing agent metering valve 24 and comparing said value to a threshold value. In so doing, if the temperature determined is less than the threshold value, the reducing agent metering valve 24 is actuated with a second flow profile that is different from the first profile. Configurations of the control device 14 are equipped for the purpose of controlling a progression of a method according to one of the dependent procedural claims.

The threshold value is preferably predetermined in such a way that it separates temperature ranges with a danger of freezing up from those without said danger. The temperature of the reducing agent metering valve is measured and/or modeled. A measurement takes place in one configuration via one special temperature sensor, which is not depicted in FIG. 1. In an additional configuration, the temperature can be determined as a result of the current being measured through the magnetic coil of the reducing agent metering valve 24, the magnetic coil's resistance being suggested via Ohm's Law. Via said resistance, the temperature of said coil is then suggested as a value for the temperature of the reducing agent metering valve 24. In internal combustion engines 10, wherein the ambient temperature, for example the intake air temperature, is determined, a value for the temperature of the reducing agent metering valve 24 can be modeled on the basis of the ambient temperature determined and a temperature measured in the exhaust gas system 12 or modeled for the exhaust gas system 12. By a modeling, a mathematical reproduction of the temperature as a function of the mathematical relationships deposited in the control device 14 is to be understood while further taking into account the aforementioned temperatures and/or other operating parameters of the internal combustion engine 10 or the exhaust gas system 12.

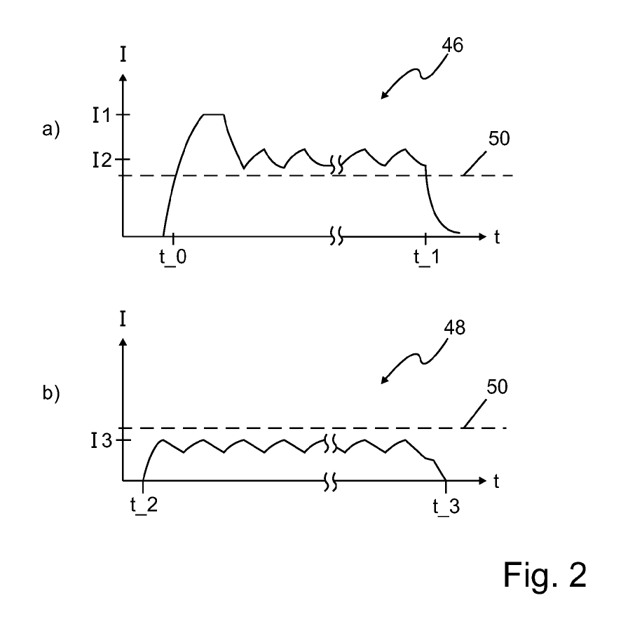

In part ‘a’ of FIG. 2, a configuration of a first flow profile 46 is shown; and in part ‘b’ of said Figure, a configuration of a second flow profile 48 is shown. In so doing, the dashed horizontal line 50 respectively designates in FIG. ‘2a’ as well as in FIG. ‘2b’ a flow level, which is required to open and hold open the reducing agent metering valve 24. The first flow profile 46 has a first part, wherein the current I through the magnetic coil of the reducing agent metering valve 24 is adjusted to a first, comparatively high value I1 in order to open the reducing agent metering valve 24 quickly. Subsequent to the first part, the first flow profile 46 has a second part, wherein a less amount of current I2 is set. The less amount of current I2 however still progresses above the dashed line 50, which designates a holding flow level. As a result the reducing agent metering valve 24 is opened and held open with the first flow profile between the points in time t_0 and t_1.

In contrast the second flow profile 48 has an average flow profile E3, which lies below the holding flow level required to open and hold open the reducing agent metering valve 24 so that the reducing agent metering valve 24 is not opened by the flow profile produced between the points in time t_2 and t_3. The FIG. ‘2b’ thereby shows in particular a configuration of a second flow profile 48 that is different from a first flow profile 46, with which the reducing agent metering valve 24 is actuated (opened) to meter the reducing agent 26.

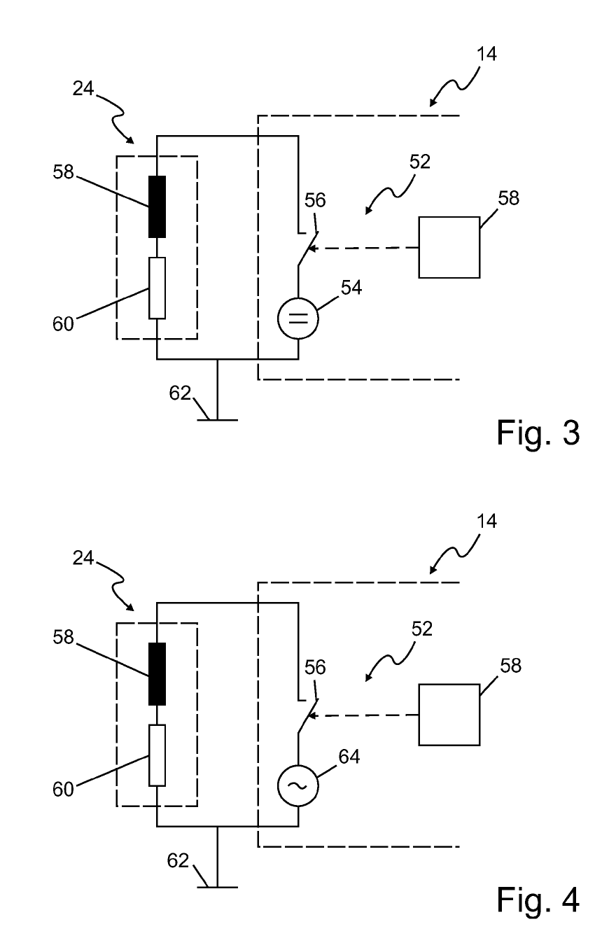

FIG. 3 shows an equivalent circuit diagram of the reducing agent metering valve 24 together with an output stage 52 of a configuration of the control device 14. The output stage 52 has a direct-current voltage supply 54 and a switch 56, which is actuated by an additional component 58 of the control device 14. The block 58 summarizes in this respect the hardware aspects of a processing of input signals by the control device 14, i.e. in particular an input signal conditioning and processing with the aid of a program deposited in the memory of the control device 14. In the equivalent circuit diagram of the reducing agent metering valve 24, the magnetic coil is depicted as a series arrangement composed of a pure inductance 58 and an ohmic resistance 60. A terminal of the direct-current voltage supply 54 and the magnetic coil of the reducing agent metering valve 24 is connected in each case to a reference potential 62, for example a control device ground. The terminals of the magnetic coil and the direct-current voltage supply 54, which are complimentary in each case, are connected to and disconnected from each other via the switch 56.

The current profiles 46 and 48 from FIG. 2 are produced as a result of the configuration of FIG. 52 of FIG. 3 by means of a corresponding open-loop control of the switch 56. The current level I1 occurs, for example, as a result of the switch 56 being closed up until the induction voltage of the inductance 58 has faded out to the extent that the entire or approximately entire direct voltage arises across the magnetic coil. The direct voltage provided by the direct-current voltage supply 54 is preferably greater than a threshold voltage, whereat a reducing agent metering valve that is not frozen up opens. The current levels 12 and 13 occur in contrast as a result of the switch 56 being alternately opened (current rise) and closed (current drop) when the induction voltages have not yet faded out.

A release of joulean heat is connected with every current flow through the magnetic coil of the reducing agent metering valve 24 on account of the ohmic resistance 60. If the reducing agent metering valve 24 is actuated with the first flow profile 46 in order to meter the reducing agent 26, this heat release can be disturbing. This is then particularly true if the metering occurs when the exhaust gas system 12 and the exhaust gas are hot. This is the case because the danger of thermal damage to the reducing agent metering valve 24 then exists. The reduction of the current intensity from the value I1 to the value I2, which is still sufficient to hold the reducing agent metering valve 24 open, reduces the heat release by the ohmic resistance 60 of the magnetic coil, which is disturbing in this instance.

When the temperature of the exhaust gas system 12 and/or the exhaust gas of the internal combustion engine 10 are lower, the release of joulean heat within the ohmic resistance 60 is used for a desired heating of the reducing agent metering valve 24. The second flow profile 48 in FIG. 2 depicts in this context a configuration of a flow profile, wherein an average current flow 13 is produced to heat the reducing agent metering valve 24, which is, however, so small that an opening of the reducing agent metering valve 24 and thereby a metering of the reducing agent 24 into the exhaust gas system 12 does not yet occur. In this configuration, the second flow profile 48 is produced by applying a clocked direct voltage to a magnetic coil of the actuating elements of the reducing agent metering valve 24.

The production of different flow profiles 46 and 48 thereby allows for a balancing-out of the metering effect and the heating effect of the current I through the magnetic coil of the reducing agent metering device 24 in that a heating of the reducing agent metering valve 24 without the simultaneous metering of the reducing agent is possible. This is true independent of the fact whether the reducing agent metering valve 24 and the feed line 30 are filled with the reducing agent 26 or not.

It is, however, to be understood that a heating effect by a second flow profile 48 can also be produced in a metering operation. In one configuration, this occurs as a result of the second current profile 48 being produced by applying the entire direct voltage to the magnetic coil of the actuating elements of the reducing agent metering valve 24 without a clocked switching on and off of the direct-current voltage supply 54. It is furthermore to be understood that the second flow profile can have all conceivable mixed forms of the flow profiles 46 and 48. In this way, the basic current level 13 of the second flow profile 48 can be maintained over a longer time period in order to achieve a continuous heating effect. If then a metering of the reducing agent 26 should additionally occur, the difference to the first flow profile 46, the first flow profile 46 or the holding current I2 of the first flow profile 46 are superimposed onto the basic current level I3 in order to produce a second flow profile. In this case the reducing agent metering valve 24 is temporarily opened, the heating effect also remaining intact when the reducing agent metering valve 24 is not open.

In order to achieve an increased heating effect without the metering of the reducing agent 26, provision is made in an additional configuration for the control device 14 to control the pump 32 in such a way that the pump 32 sucks the reducing agent out of the feed line 30 and the reducing agent metering valve 24 back into to storage container 28. In this case the now pressureless reducing agent metering valve can be heated with high amounts of current and thereby with large heating effects without an undesirable metering of the reducing agent 26 into the exhaust gas system 12 occurring.

FIG. 4 shows an additional configuration, wherein the control device 14 is equipped for the purpose of producing a second flow profile by applying an alternating-current voltage to a magnetic coil of the actuating elements of the reducing agent metering valve. The output stage 52 thereby has an alternating-current voltage supply 64, which replaces or supplements the direct-current voltage supply 54 from FIG. 3. With the necessary changes, all of the configurations explained in connection with FIG. 3 can also be achieved with the alternating-current voltage supply 64 according to FIG. 4. Hence, an alternating-current voltage supply 64, for example an alternating-current voltage supply with controllable frequency, can be operated with such a high frequency that the reducing agent metering valve 24 can not follow this frequency on account of its mechanical inertia.

The alternating current, which nevertheless flows through the ohmic resistance 60, then heats up the reducing agent metering valve 24. This configuration can also be implemented independent of a filling of the reducing agent metering valve 24 and its feed line 30 with the reducing agent 26.

If an opening of the reducing agent metering valve 24 is allowed or desired, provision is made in a further configuration for an operation with a frequency of the alternating-current voltage, which is so low that a non-frozen reducing agent metering valve 24 opens and closes with the frequency of the alternating-current voltage. The altered frequency can either result from alternatively putting an additional alternating-current voltage supply into the circuit, which provides an alternating current with low frequency, or from a controlled alteration of the frequency of the alternating-current voltage supply 64.

As a further alternative, the magnetic coil can alternatively or additionally be connected to a direct-current voltage supply 54 and an alternating-current voltage supply 64 so that the magnetic coil is supplied only with the current from one of the two voltage supplies 54, 64 or with the total sum of the currents.

It is also true in this instance that an opening of the reducing agent metering valve 24 is allowed if the reducing agent is sucked back out of the feed line 30 and the reducing agent metering valve 24 prior to said opening.

In order to additionally improve the heating effect, provision is made in a further configuration for the reducing agent metering valve 24 and its feed line 30 to alternately be filled with and emptied of the reducing agent 26 in order to convey heat with warm reducing agent 26 to parts of the system, which are not electrically heated. In so doing, the reducing agent 26 is in each case heated by the heater 33 and/or 34 and pumped back and forth in the system by the pump 32.

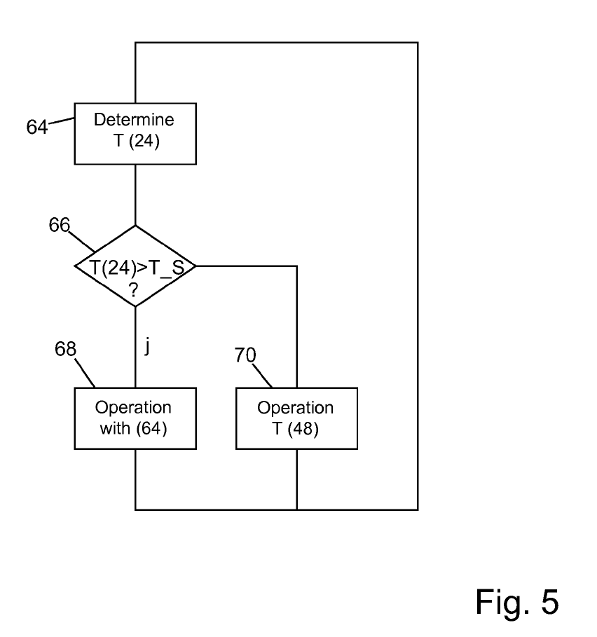

FIG. 5 shows a configuration of a method for operating the electromagnetically controllable reducing agent metering valve 24, as it is controlled by the control device 14. According to the method, the temperature T(24) of the reducing agent metering valve 24 is determined in step 64. As was previously described above, this can occur by means of measuring and/or modeling. Subsequently the temperature, which was so determined, is compared in Step 66 with a predetermined threshold value T_S, which separates temperature ranges with the danger of freezing up from those without said danger. If T(24) is greater than the threshold value T_S, the program branches out to Step 68, wherein the reducing agent metering valve is operated with the first flow profile 46 without special heating measures. If the temperature T(24) is on the other hand smaller than the threshold value T_S, an operation of the reducing agent metering valve 24 occurs with the second flow profile 48.

1-12. (canceled)

13. A method of operating an electromagnetically controllable reducing agent metering valve that is positioned in an exhaust gas system of an internal combustion engine, the method comprising:
determining a first temperature value of the reducing agent metering valve; and
comparing the first temperature value to a threshold temperature value, wherein the reducing agent metering valve is actuated with a first flow profile when the first temperature value is greater than the threshold temperature value and actuated with a second flow profile when the first temperature value is less than the threshold temperature value.

14. The method according to claim 13, further comprising producing the second flow profile by applying a direct voltage to a magnetic coil of actuating elements of the reducing agent metering valve.

15. The method according to claim 13, further comprising producing the second flow profile by applying an alternating-current voltage to a magnetic coil of actuating elements of the reducing agent metering valve.

16. The method according to claim 14, further comprising applying the direct voltage such that still the reducing agent metering valve is not actuated to open.

17. The method according to claim 15, further comprising applying a high enough frequency of alternating-current voltage such that the reducing agent metering valve does not open due to mechanical inertia of the reducing agent metering valve.

18. The method according to one of claims 16, further comprising applying the voltage independent of a filling of the reducing agent metering valve and a feed line with a reducing agent.

19. The method according to claim 14, further comprising applying a direct voltage magnitude that is greater than a threshold voltage magnitude in which a non-frozen reducing agent metering valve opens.

20. The method according to claim 15, further comprising applying the alternating-current voltage with a frequency that is low enough such that a non-frozen reducing agent metering valve opens and closes at the frequency of the alternating-current voltage.

21. The method according to claim 19, further comprising evacuating a reducing agent out of the reducing agent metering valve and a feed line prior to applying the voltage.

22. The method according to claim 13, further comprising alternatively filling and evacuating the reducing agent metering valve and a feed line with the reducing agent to convey heat with warm reducing agent to a plurality of parts of the exhaust gas system that are not electrically heated.

23. A control device configured to implement a method of operating an electromagnetically controllable reducing agent metering valve that is positioned in an exhaust gas system of an internal combustion engine, the method comprising: determining a first temperature value of the reducing agent metering valve; and comparing the first temperature value to a threshold temperature value, wherein the reducing agent metering valve is actuated with a first flow profile when the first temperature value is greater than the threshold temperature value and actuated with a second flow profile when the first temperature value is less than the threshold temperature value.

24. The control device of claim 23, wherein the control device is further configured to implement a method of operating an electromagnetically controllable reducing agent metering valve that is positioned in an exhaust gas system of an internal combustion engine, the method comprising:
determining a first temperature value of the reducing agent metering valve; and
comparing the first temperature value to a threshold temperature value, wherein the reducing agent metering valve is actuated with a first flow profile when the first temperature value is greater than the threshold temperature value and actuated with a second flow profile when the first temperature value is less than the threshold temperature value.
